(19) United States
(12) Patent Application Publication
(10) Pub. No.: US 2019/0176578 A1
(43) Pub. Date: Jun. 13, 2019

(54) ELECTRIC COMPRESSOR SPEED CONTROL FOR BATTERY CHILLER IN ELECTRIFIED VEHICLES

(71) Applicant: FORD GLOBAL TECHNOLOGIES, LLC, Dearborn, MI (US)

(72) Inventors: Timothy Noah BLATCHLEY, Dearborn, MI (US); James GEBBIE, Rochester Hills, MI (US); Angel Fernando PORRAS, Dearborn, MI (US)

(21) Appl. No.: 15/836,404

(22) Filed: Dec. 8, 2017

(51) Int. Cl. B60H 1/32; B60H 1/00

(52) U.S. Cl. CPC B60H 1/3216; B60H 1/00385; B60H 2001/3272; B60H 1/00328; B60H 1/00278

(57) ABSTRACT

A thermal system for a vehicle includes a compressor configured to pressurize refrigerant that selectively flows through a chiller for battery coolant and an evaporator for cabin cooling. The system further includes a controller programmed to, responsive to cabin cooling demand becoming zero, change from adjusting compressor speed responsive to changes in an evaporator temperature to adjusting compressor speed responsive to changes in a chiller refrigerant pressure.

### TECHNICAL FIELD

This application generally relates to a thermal management system for a traction battery in a hybrid vehicle.

### BACKGROUND

A vehicle includes components and systems that require temperature management. For example, temperature of an engine is regulated by flowing coolant through the engine and using a radiator to reduce the temperature of the coolant. Hybrid vehicles include additional components for which temperature management is beneficial. For example, performance of traction batteries and power electronics modules may depend on maintaining the temperatures below a maximum limit. Additional cooling systems may be installed in the vehicle to provide thermal management for traction batteries and power electronics modules.

### SUMMARY

A vehicle includes a coolant loop configured to flow a coolant through a battery. The vehicle further includes a compressor configured to pressurize refrigerant that selectively flows through a chiller for the coolant and an evaporator for cabin cooling. The vehicle includes a controller programmed to, responsive to cabin cooling demand becoming zero, change from adjusting compressor speed responsive to changes in an evaporator refrigerant temperature to adjusting compressor speed responsive to changes in a chiller refrigerant pressure.

A vehicle thermal system includes a compressor configured to pressurize refrigerant that selectively flows through a chiller for battery coolant and an evaporator for cabin cooling. The vehicle thermal system further includes a controller programmed to, responsive to cabin cooling demand becoming zero, change from adjusting compressor speed responsive to changes in an evaporator temperature to adjusting compressor speed responsive to changes in a chiller refrigerant pressure.

The controller may be further programmed to, responsive to cabin cooling demand becoming nonzero, change from adjusting compressor speed responsive to changes in the chiller refrigerant pressure to adjusting compressor speed responsive to changes in the evaporator temperature. The controller may be further programmed to, responsive to cabin cooling demand being zero, adjust compressor speed responsive to changes in a chiller refrigerant target temperature. The controller may be further programmed to, responsive to cabin cooling demand being zero, adjust compressor speed responsive to changes in an error between a chiller refrigerant target pressure derived from the chiller refrigerant target temperature and the chiller refrigerant pressure. The controller may be further programmed to derive the chiller refrigerant target pressure based on a type of refrigerant. The controller may be further programmed to change the chiller refrigerant target temperature responsive to changes in a coolant temperature associated with the battery. The controller may be further programmed to change the chiller refrigerant target temperature responsive to changes in a temperature associated with the battery.

A method for operating, in a vehicle, a compressor configured to pressurize refrigerant that selectively flows through a chiller for battery coolant and an evaporator for cabin cooling includes, responsive to a demand for cabin cooling becoming zero, changing, by a controller, from adjusting a speed of the compressor responsive to changes in a temperature of the evaporator to adjusting the speed responsive to changes in a refrigerant pressure associated with the chiller.

The method may further include changing, by the controller, responsive to the demand for cabin cooling demand becoming nonzero, from adjusting the speed responsive to changes in the chiller refrigerant pressure to adjusting the speed responsive to changes in the temperature of the evaporator. The method may further include adjusting, by the controller, responsive to cabin cooling demand being zero, compressor speed responsive to changes in a chiller refrigerant target temperature. The method may further include adjusting, by the controller, responsive to cabin cooling demand being zero, compressor speed responsive to changes in an error between the chiller refrigerant pressure and a chiller refrigerant target pressure that is derived from the chiller refrigerant target temperature. The method may further include changing, by the controller, the chiller refrigerant target temperature responsive to changes in a temperature of the battery coolant. The method may further include changing, by the controller, the chiller refrigerant target temperature responsive to changes in a temperature associated with a battery through which the battery coolant flows.

### BRIEF DESCRIPTION OF THE DRAWINGS

FIG. 1 is a diagram of an electrified vehicle illustrating typical drivetrain and energy storage components.

FIG. 2 is a diagram of a cooling loop in an electrified vehicle.

FIG. 3 is a flow chart of a possible sequence of operations for controlling a thermal management system.

FIG. 4 depicts a possible block diagram for operating the compressor.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

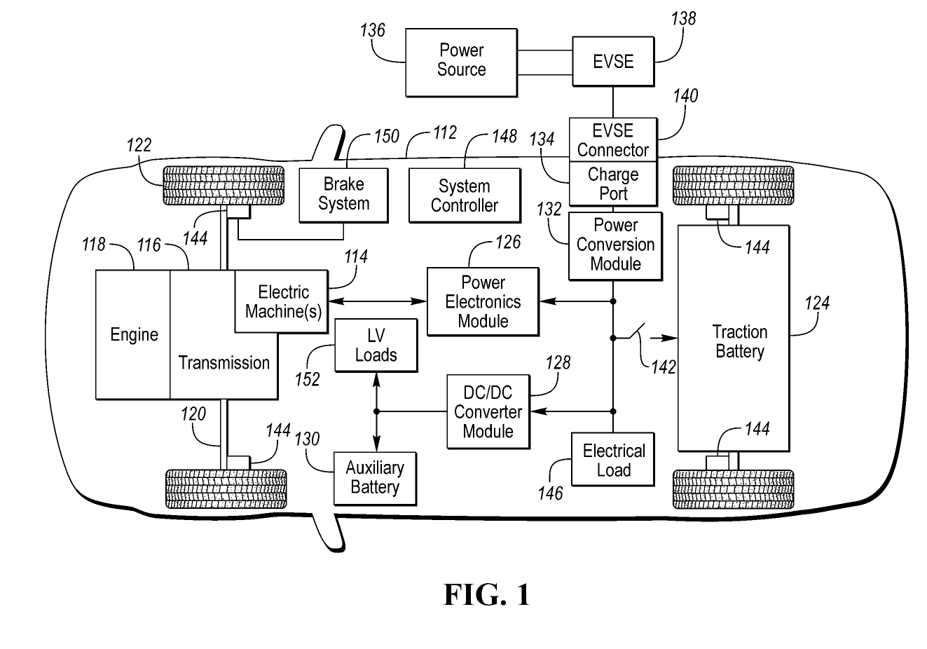

FIG. 1 depicts an electrified vehicle 112 that may be referred to as a plug-in hybrid-electric vehicle (PHEV). A plug-in hybrid-electric vehicle 112 may comprise one or more electric machines 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 can provide propulsion and deceleration capability when the engine 118 is turned on or off. The electric machines 114 may also act as generators and can provide fuel economy benefits by recovering energy that would normally be lost as heat in a friction braking system. The electric machines 114 may also reduce vehicle emissions by allowing the engine 118 to operate at more efficient speeds and allowing the hybrid-electric vehicle 112 to be operated in electric mode with the engine 118 off under certain conditions. An electrified vehicle 112 may also be a battery electric vehicle (BEV). In a BEV configuration, the engine 118 may not be present. In other configurations, the electrified vehicle 112 may be a full hybrid-electric vehicle (FHEV) without plug-in capability.

A traction battery or battery pack 124 stores energy that can be used by the electric machines 114. The vehicle battery pack 124 may provide a high voltage direct current (DC) output. The traction battery 124 may be electrically coupled to one or more power electronics modules 126. One or more contactors 142 may isolate the traction battery 124 from other components when opened and connect the traction battery 124 to other components when closed. The power electronics module 126 is also electrically coupled to the electric machines 114 and provides the ability to bi-directionally transfer energy between the traction battery 124 and the electric machines 114. For example, a traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to the DC voltage compatible with the traction battery 124.

In addition to providing energy for propulsion, the traction battery 124 may provide energy for other vehicle electrical systems. The vehicle 112 may include a DC/DC converter module 128 that converts the high voltage DC output of the traction battery 124 to a low voltage DC supply that is compatible with low-voltage vehicle loads 152. An output of the DC/DC converter module 128 may be electrically coupled to an auxiliary battery 130 (e.g., 12V battery) for charging the auxiliary battery 130. The low-voltage systems 152 may be electrically coupled to the auxiliary battery 130. One or more electrical loads 146 may be coupled to the high-voltage bus. The electrical loads 146 may have an associated controller that operates and controls the electrical loads 146 when appropriate. Examples of electrical loads 146 may be a fan, an electric heating element and/or an air-conditioning compressor.

The electrified vehicle 112 may be configured to recharge the traction battery 124 from an external power source 136. The external power source 136 may be a connection to an electrical outlet. The external power source 136 may be electrically coupled to a charger or electric vehicle supply equipment (EVSE) 138. The external power source 136 may be an electrical power distribution network or grid as provided by an electric utility company. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled or connected may transfer power using a wireless inductive coupling.

One or more wheel brakes 144 may be provided for decelerating the vehicle 112 and preventing motion of the vehicle 112. The wheel brakes 144 may be hydraulically actuated, electrically actuated, or some combination thereof. The wheel brakes 144 may be a part of a brake system 150. The brake system 150 may include other components to operate the wheel brakes 144. For simplicity, the figure depicts a single connection between the brake system 150 and one of the wheel brakes 144. A connection between the brake system 150 and the other wheel brakes 144 is implied. The brake system 150 may include a controller to monitor and coordinate the brake system 150. The brake system 150 may monitor the brake components and control the wheel brakes 144 for vehicle deceleration. The brake system 150 may respond to driver commands and may also operate autonomously to implement features such as stability control. The controller of the brake system 150 may implement a method of applying a requested brake force when requested by another controller or sub-function.

Electronic modules in the vehicle 112 may communicate via one or more vehicle networks. The vehicle network may include a plurality of channels for communication. One channel of the vehicle network may be a serial bus such as a Controller Area Network (CAN). One of the channels of the vehicle network may include an Ethernet network defined by Institute of Electrical and Electronics Engineers (IEEE) 802 family of standards. Additional channels of the vehicle network may include discrete connections between modules and may include power signals from the auxiliary battery 130. Different signals may be transferred over different channels of the vehicle network. For example, video signals may be transferred over a high-speed channel (e.g., Ethernet) while control signals may be transferred over CAN or discrete signals. The vehicle network may include any hardware and software components that aid in transferring signals and data between modules. The vehicle network is not shown in FIG. 1 but it may be implied that the vehicle network may connect to any electronic module that is present in the vehicle 112. A vehicle system controller (VSC) 148 may be present to coordinate the operation of the various components.

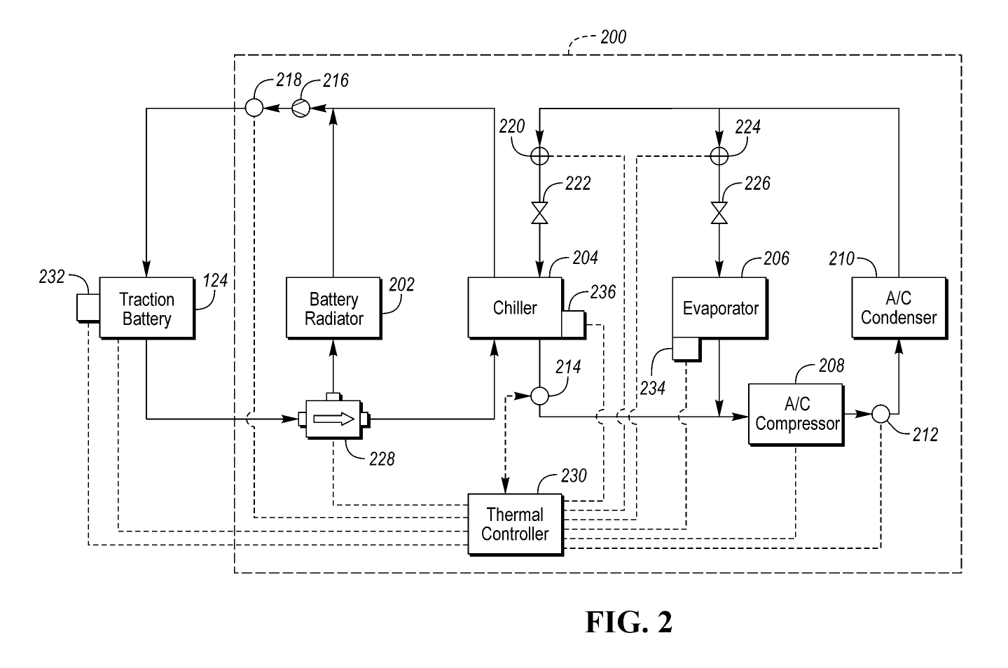

The vehicle 112 may include a thermal management system 200 for controlling the temperature of the traction battery 124. FIG. 2 depicts a diagram for the thermal management system 200 for the electrified vehicle 112. The vehicle 112 may include a coolant loop that is configured to route a coolant through the traction battery 124 for thermal management. The vehicle 112 may include an additional coolant loop that is configured to route coolant through the engine 118 and other powertrain systems. The thermal management system 200 may include the components and subsystems described herein.

The vehicle 112 may include a cabin climate control system. The cabin climate control system may be configured to provide heating and cooling for the cabin of the vehicle 112. In a typical configuration, coolant that flows through the engine 118 to remove heat from the engine 118 is flowed through a heater core. In other configurations, the coolant may be heated by an electrical heater (e.g., electric vehicle). The heater core transfers heat from the coolant to air around the heater core which may be forced into the cabin with a variable speed fan.

Referring to FIG. 2, cooling of the cabin and traction battery 124 may be accomplished with an air conditioning system. The air-conditioning system may include various components including a compressor 208, a condenser 210, and a cabin evaporator 206. The air-conditioning components may be coupled via tubes or pipes that facilitate transport of a refrigerant between the components. The compressor 208 may be configured to control the pressure of the refrigerant. The compressor 208 may be driven by an electric machine that may be powered from a high-voltage bus associated with the traction battery 124 or a low-voltage bus associated with the auxiliary battery 130. A compressor control module may be configured to operate the electric machine to drive the compressor 208. The compressor control module may communicate with other controllers (e.g., system controller 148) via the vehicle network.

The system may include a refrigerant pressure sensor 212 that is configured to measure the refrigerant pressure associated with the compressor 208. For example, the refrigerant pressure sensor 212 may be configured to measure the refrigerant pressure at an outlet side of the compressor 208. The pressure of the refrigerant may depend upon a speed of the compressor 208. For example, the refrigerant pressure may increase in response to an increase in the speed of the compressor 208. The refrigerant may flow to a condenser 210 that is configured to remove heat from the refrigerant. That is, the refrigerant is cooled as it passes through the condenser 210. The refrigerant may change from a gaseous to a liquid state as it passes through the condenser 210. The refrigerant may then be passed through a cabin expansion valve 226 that regulates the flow of refrigerant to the cabin evaporator 206. The refrigerant may then pass through the cabin evaporator 206 that transfers heat from the surrounding air to the refrigerant. The refrigerant may change from a liquid to a gaseous state as it passes through the cabin evaporator 206. The temperature and water content of the air that flows across the cabin evaporator 206 decreases. For cabin cooling, a fan may push cabin air across the cabin evaporator 206 to facilitate the heat transfer. The thermal management system 200 may further include an evaporator temperature sensor 234. The evaporator temperature sensor 234 may be configured to measure a temperature associated with the cabin evaporator 206. The evaporator temperature sensor 234 may be disposed at an outlet port of the cabin evaporator 206. The evaporator temperature sensor 206 may be disposed in an air stream flowing across the cabin evaporator 206.

The air conditioning system may be further configured to cool the traction battery 124. To facilitate cooling of the traction battery 124 the thermal management system 200 may include a chiller 204. The chiller 204 facilitates heat transfer between the refrigerant and coolant flowing through that traction battery 124. The thermal management system 200 may include a chiller expansion valve 222 that is configured to regulate the flow of refrigerant to the chiller 204. The chiller 204 may operate in a manner similar to the cabin evaporator 206. As the refrigerant pressure decreases, the temperature of the refrigerant may decrease. The refrigerant may flow through the chiller 204 and heat from the coolant may be transferred to the refrigerant. As the refrigerant pressure decreases, the temperature of the refrigerant may decrease. The chiller 204 may include coils of refrigerant lines interspersed with coils of coolant lines to transfer heat from the coolant to the refrigerant. The chiller 204 may be comprised of brazed plates forming alternating chambers through which refrigerant and coolant flow. The thermal management system 200 may further include a chiller temperature sensor 236 that is configured to measure a temperature associated with the chiller 204. For example, the chiller temperature sensor 236 may be configured to measure the temperature of the refrigerant at an outlet of the chiller 204.

The thermal management system 200 may further include control valves to control the flow of refrigerant and coolant. The thermal management system 200 may include a cabin control valve 224 that is configured to selectively flow refrigerant to the cabin evaporator 206 and the cabin expansion valve 226. The thermal management system 200 may include a chiller control valve 220 that is configured to selectively flow refrigerant to the chiller expansion valve 222 and the chiller 204. The chiller expansion valve 222 and the cabin expansion valve 226 may be thermal expansion valves and/or constant area devices. The control valves may be controlled by solenoids. The control valves may be on/off type valves such that the valves are either in an on position or an off position.

The thermal management system 200 may include a thermal management controller 230. The thermal management controller 230 may include a processor for executing instructions. The thermal management controller 230 may include volatile and non-volatile memory for storing programs and data. Non-volatile memory may include any memory configured to retain information when power is removed. The thermal management controller 230 may include input and output circuitry to facilitate the transfer of signals to any connected devices. The thermal management controller 230 may include a processor and memory for implementing the control instructions and storing parameters. In addition, the thermal management controller 230 may include input/output (I/O) interfaces configured to receive feedback signals and output control signals to various control devices. Note that the functions implemented by the thermal management controller 230 may be incorporated into another controller in the vehicle (e.g. system controller 148). Pressure and temperature sensors may be electrically coupled to the thermal management controller 230. Control valves, pumps, and compressors may be electrically coupled to the thermal management controller 230 to allow for control.

The thermal management controller 230 may be in communication with the cabin climate control system (e.g., via the vehicle network). The thermal management controller 230 may receive signals indicative of the state of the cabin climate control system. The thermal management controller 230 may receive or otherwise determine a cabin cooling demand. For example, the thermal management controller 230 may receive a signal indicative of the level of requested cabin cooling demand. The thermal management controller 230 may receive a signal indicative of the actual level of cabin cooling. For example, these values may be temperatures such as a setpoint temperature and an actual cabin temperature. The thermal management controller 230 may receive inputs from an occupant control panel. The inputs may include a cabin temperature setpoint and a desired fan speed. Other inputs may include a selected mode of heating or cooling (e.g., vent, floor vent, window defroster). The inputs may include an on/off signal for the cabin heating/cooling function.

The thermal management system 200 may include one or more temperature sensors. For example, a cabin temperature sensor may provide a temperature measurement for the cabin. The thermal management controller 230 may receive the temperature sensor inputs and control the cabin temperature to the desired cabin temperature setpoint. The thermal management system 200 may include a manual mode of operation in which the occupants control the speed of the fan and the temperature of the air entering the’ cabin.

In addition to controlling the climate in the cabin, various other vehicle components may benefit from control of the temperature. For example, the traction battery 124 may be configured to operate in a particular temperature range to achieve best performance. The optimal temperature range may affect the battery power capability and the battery life. By operating within the temperature range, battery life and capability may be maintained.

The thermal management system 200 of the vehicle 112 may include a coolant loop that is configured to route coolant through the traction battery 124. The coolant loop may include pipes, lines, tubes, and connectors through which the coolant may flow. The coolant loop may include a number of paths through which coolant may be flowed. The paths through which coolant may flow may be controlled by various valves to be described herein. Each of the paths may include any conduits and connections as necessary to facilitate the flow of coolant through the associated path.

The traction battery 124 may include a heat exchanger that is configured to transfer heat between the coolant and the traction battery 124. The battery heat exchanger may transfer heat between the traction battery 124 and a coolant flowing through the battery heat exchanger. Heat transfer between the traction battery 124 and the coolant may be a function of the battery temperature, the coolant temperature, and the flow rate of the coolant. The battery heat exchanger may transfer heat from the coolant to the traction battery 124 if the coolant temperature is greater than the traction battery temperature. The battery heat exchanger may transfer heat from the traction battery 124 to the coolant if the coolant temperature is less than the traction battery temperature. The coolant loop may be used to heat and cool the traction battery 124 depending upon a desired temperature for the traction battery 124.

The battery chiller 204 may operate in a manner similar to the cabin evaporator 206. That is, the compressor 208 may change a pressure of refrigerant that is passed through an evaporative mechanism that is in thermal contact with the coolant flowing through the system. Some surfaces of the chiller 204 may be in thermal contact with the coolant in the coolant circuit. As the refrigerant passes through the chiller 204, heat from the coolant is absorbed by the refrigerant which cause the coolant in the coolant circuit to cool. Heat transfer from the coolant to the refrigerant may be a function of the temperature difference between the coolant and the refrigerant and the flow rate of the coolant. The battery chiller 204 may receive refrigerant from the same compressor 208 as the air-conditioning system. For example, one or more valves may be present in the refrigerant lines to direct refrigerant to the cabin cooling system and/or the battery chiller 204. The battery chiller 204 operates to reduce the temperature of the coolant entering the battery heat exchanger.

The thermal management system 200 of the vehicle 112 may include a pump 216 that is configured to cause coolant to flow in the coolant loop. The pump 216 may be operated to vary the flow rate of coolant through the coolant loop. The pump 216 may include an electric motor that is configured to operate a pumping mechanism. The electric motor may be controlled by adjusting a voltage or current input to cause rotation at a desired speed. In some configurations, the electric motor may be configured to operate at variable speeds to vary the flow rate of coolant through the coolant loop. The operation of the coolant loop may be such that coolant flowing through the coolant loop may traverse through selected paths and return to the pump 216 for continued recirculation through the coolant loop.

The thermal management controller 230 may be further configured to control and manage the flow of coolant through the battery coolant loop. The thermal management system 200 of the vehicle 112 may include a radiator 202 within the battery coolant loop. The coolant loop may define a radiator path that routes coolant through the radiator 202. The radiator 202 may be configured to transfer heat from the coolant to the air. As coolant flows through the radiator 202 heat from the coolant is transferred to air passing by the radiator 202. The radiator 202 may include a series of tubes through which coolant flows from one side of the radiator 202 to another side. In between the tubes and in contact with adjacent tubes may be metal formed in a corrugated pattern that increases a surface area for heat transfer. Coolant exiting the radiator 202 is generally at a lower temperature than coolant entering the radiator 202.

The thermal management system of the vehicle 112 may include temperature sensors that are placed in various locations to measure component and/or coolant temperatures. A battery coolant temperature sensor 218 may be configured to measure a temperature of coolant in the battery coolant loop. For example, the battery coolant temperature sensor 218 may be located near the coolant inlet of the traction battery 124. In addition, one or more traction battery temperature sensors 232 may be configured to measure temperatures associated with the traction battery 124. For example, the traction battery temperature sensors 232 may measure the temperature at locations within the traction battery 124 that are indicative of temperatures of cells that make up the traction battery 124. Each of the temperature sensors (e.g., 218, 232) may be electrically coupled to the thermal management controller 230. For example, outputs from each of the temperature sensors may be electrically wired to the thermal management controller 230. In other configurations, the thermal management controller 230 may receive temperature information from the temperature sensors via the vehicle network (e.g., CAN bus). The thermal management controller 230 may implement a control strategy to maintain the temperature associated with the traction battery 124 within a predetermined temperature range.

The thermal management system 200 of the vehicle 112 may include a battery control valve 228 that is configured to selectively route coolant in the battery coolant loop through the chiller 204 or the radiator 202. The battery control valve 228 may include a solenoid coupled to a valve mechanism such that a position of the battery control valve 228 may be controlled by the thermal management controller 230. For example, a battery control valve control signal may be output from the thermal management controller 230 to control the position of the battery control valve 228. Using the battery control valve control signal, the thermal management controller 230 may command the position of the battery control valve 228.

The battery control valve 228 may be controlled to a first position and a second position. The position may be selected based on measured and desired temperatures associated with the coolant and the traction battery 124. When controlled to the first position (e.g., chiller flow position), the battery control valve 228 may route coolant between the chiller 204 and the traction battery 124. The first position may be selected when the battery temperature is above a predetermined threshold. In this mode, battery coolant may be actively cooled to maintain the coolant temperature within a predetermined range. In some configurations, the battery control valve 228 may be a proportional valve providing a range of flow positions.

When controlled to the second position (e.g., radiator flow position), the battery control valve 228 may route coolant to the coolant path that includes the radiator 202 and the traction battery 124. The second position may be the default position and may further be selected when the battery temperature is below the predetermined threshold. In this mode, the battery coolant is cooled by the radiator 202.

The traction battery 124 may operate best within a predetermined temperature range. When the temperature of the traction battery 124 falls outside of the predetermined temperature range, performance of the traction battery 124 may decrease. Within the predetermined temperature range, battery power capability and capacity may be maintained at rated levels. It may be desired to maintain the battery 124 at a temperature that is below a maximum operating temperature. The thermal management controller 230 may be programmed to operate the thermal management system 200 to maintain the temperature of the traction battery within the predetermined temperature range. The thermal management controller 230 may be further programmed to determine whether the traction battery 124 can be sufficiently cooled by the radiator 202 or the chiller 204.

When there is a demand for cabin cooling, the thermal management controller 230 may operate the air conditioning compressor 208 to satisfy the demand. When there is demand for cabin cooling, the thermal management controller 230 may operate the cabin control valve 224 to flow refrigerant to the cabin evaporator 206 and the cabin expansion valve 226. This allows the cabin to be cooled. The thermal management controller 230 may control the speed of the compressor 208 based on a temperature associated with the evaporator 206. The temperature associated with the evaporator 206 may represent a saturation temperature of the evaporator 206. For example, the compressor speed may be adjusted based on an error between a target evaporator temperature and the evaporator temperature. The target evaporator temperature may be based on an amount of cabin cooling that is desired (e.g., cabin temperature setpoint). The control scheme prioritizes cabin cooling and operates the compressor 208 at a speed to ensure that the demand for cabin cooling is satisfied.

In presence of the demand for cabin cooling, the thermal management controller 230 may further determine if there is a need for battery cooling. For example, battery cooling may be requested if the battery temperature exceeds a predetermined temperature and/or if the battery temperature is more than a predetermined amount from a target battery temperature. If battery cooling is needed, the thermal management controller 230 may operate the chiller control valve 220 to flow refrigerant to the chiller expansion valve 222 and the chiller 204. The thermal management controller 230 may further operate the battery control valve 228 to a position to flow coolant through the chiller 204. As the compressor 208 is operating due to the demand for cabin cooling, the chiller 204 may receive refrigerant for cooling the battery 124. The thermal management controller 230 may continue to manage the compressor speed based on the cabin cooling demand. Any changes in the evaporator temperature due to refrigerant flowing to the chiller 204 may cause a compressor speed change in the manner described herein.

In the absence of demand for cabin cooling, the thermal management controller 230 may operate the cabin control valve 224 to prevent refrigerant from flowing to the cabin evaporator 206 and the cabin expansion valve 226. Further, the thermal management controller 230 may command the speed of the compressor 208 to zero. Further, as the flow of refrigerant to the cabin evaporator 206 is stopped, control of the compressor based on the evaporator temperature is no longer appropriate or necessary. If a demand for battery cooling remains, the compressor speed may be controlled in an alternative manner.

The thermal management controller 230 may be programmed to control the compressor speed based on a chiller refrigerant temperature. For example, the compressor speed may be adjusted based on an error between a chiller refrigerant target temperature and the chiller refrigerant temperature. The control scheme improves fuel economy as the compressor 208 may be operated at a lowest speed or energy level to achieve the battery cooling demand. The chiller refrigerant temperature may be derived from the chiller temperature sensor 236. The chiller refrigerant target temperature may change according to changes in a target temperature and/or a temperature associated with the traction battery 124. The chiller refrigerant target temperature may further change responsive to changes in battery power demand. For example, chiller refrigerant target temperature may be changed based on a target battery inlet coolant temperature. In other configurations, the chiller refrigerant target temperature may be changed based on a battery temperature.

The thermal management controller 230 may be programmed to control the compressor speed based on a chiller refrigerant pressure. For example, the compressor speed may be adjusted based on an error between a chiller refrigerant target pressure and the chiller refrigerant pressure. The thermal management system 200 may further include a chiller refrigerant pressure sensor 214. The chiller refrigerant pressure sensor 214 may be configured to provide a signal indicative of the refrigerant pressure associated with the chiller 204. For example, the chiller refrigerant pressure sensor 214 may measure a pressure of the refrigerant at an output of the chiller 204. The thermal management controller 230 may receive the signal and determine a chiller refrigerant pressure measurement value. In some configurations, the chiller refrigerant pressure measurement value may be used to estimate the chiller refrigerant temperature. The chiller refrigerant pressure sensor 214 also provides a way to ensure that the chiller refrigerant pressure does not fall below atmospheric pressure. In applications using the chiller refrigerant pressure sensor 214, the chiller temperature sensor 236 may not be necessary.

The thermal management controller 230 may implement a look-up table that relates chiller saturation temperatures to the chiller refrigerant pressure. The look-up table may be determined based on the type of refrigerant being used in the system. For example, a refrigerant system may use R134a or R1234yf refrigerant. A different look-up table may be used for each type of refrigerant. In configurations with a chiller pressure sensor 214, the thermal management controller 230 may receive the chiller refrigerant pressure measurement value and determine the chiller refrigerant temperature based on the chiller refrigerant pressure. In other configurations, mathematical equations representing an approximation of the temperature and pressure relationship may be implemented. For example, look-up table data may be approximated with an equation that is implemented in the thermal management controller 230.

In configurations that use the chiller refrigerant pressure for compressor speed control, the chiller refrigerant target temperature may be converted to a pressure value. For example, the look-up table that relates chiller saturation temperature to chiller refrigerant pressure may be used by using the chiller refrigerant target temperature as an index to determine a chiller refrigerant target pressure. The control strategy may then adjust the compressor speed based on a pressure error.

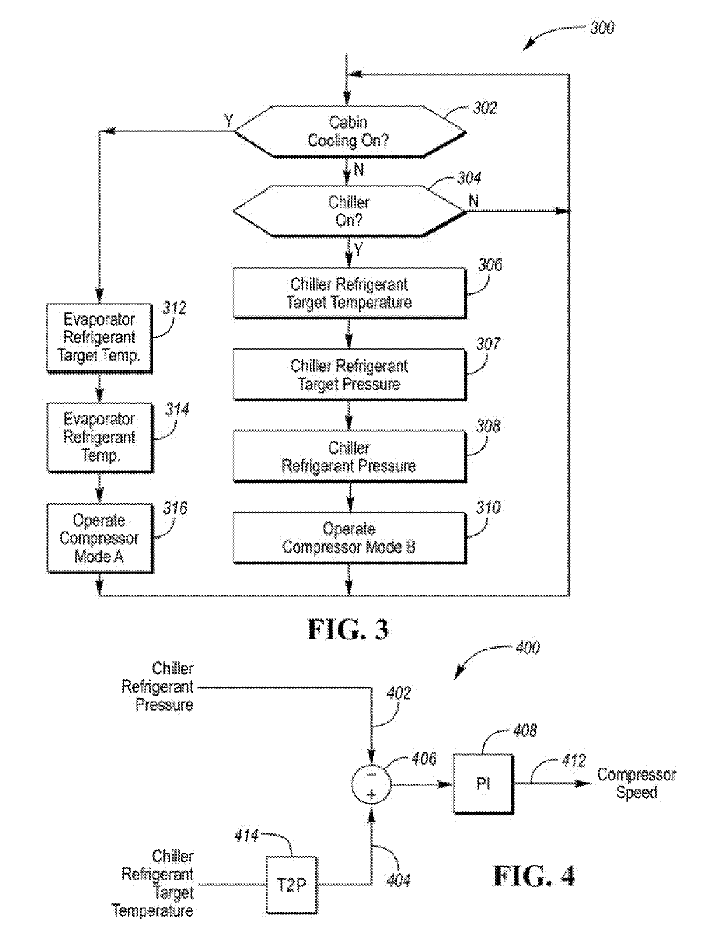

FIG. 3 depicts a flow chart 300 showing a possible sequence of operations that may be performed by the thermal management controller 230. At operation 302, a check may be performed to determine if the cabin cooling is on. That is, the system may check if there is a demand for cabin cooling. Demand for cabin cooling may be determined from the cabin controls or cabin climate control system. For example, if the cabin temperature control system is requesting that the compressor 208 be running, then a demand for cabin cooling may be recognized. A demand for cabin cooling may be recognized in response to a cabin temperature exceeding a desired temperature. If there is a demand for cabin cooling, operation 312 may be performed. In response to a demand for cabin cooling, the compressor may be controlled according to parameters associated with the cabin evaporator 206.

At operation 312, the system may determine the evaporator refrigerant target temperature. The evaporator refrigerant target temperature may be derived from the desired cabin temperature. The thermal management controller 230 may determine the evaporator refrigerant target temperature that provides the desired amount of cabin cooling. At operation 314, the system may determine the evaporator refrigerant temperature. At operation 316, the compressor 208 may be operated in a first mode. The first mode of operation may be a mode in which the speed of the compressor 208 is determined based on the evaporator refrigerant target temperature and the evaporator refrigerant temperature. The thermal management controller 230 may control the compressor speed to achieve a desired amount of cabin cooling. The thermal management controller 230 may implement a control strategy to adjust the compressor speed to satisfy the demand for cabin cooling.

If there is no demand for cabin cooling at operation 302, operation 304 may be performed. At operation 304, the system may check to determine if the battery chiller 204 is on. That is, the system may check if there is a demand for battery cooling such that refrigerant should be flowed through the chiller 204. For example, a demand for battery cooling may be present and the chiller 204 should be on if the battery temperature exceeds a predetermined temperature. The demand for battery cooling may also depend upon a temperature of the coolant in the battery coolant loop. For example, a high coolant temperature may indicate that the radiator 202 is unable to meet the battery cooling demand. If there is a demand for battery cooling, operation 306 may be performed.

At operation 306, the thermal management controller 230 may determine the chiller refrigerant target temperature as previously described herein. At operation 307, the thermal management controller 230 may determine a chiller refrigerant target pressure. The chiller refrigerant target pressure may be derived from the chiller refrigerant target temperature using the table look-up as described previously herein. At operation 308, the thermal management controller 230 may determine the chiller refrigerant pressure as previously described herein. For example, the chiller refrigerant pressure may be derived from the chiller refrigerant pressure sensor 214. At operation 310, the compressor 208 may be operated in a second mode. The second mode of operation may be a mode in which the speed of the compressor 208 is determined based on the chiller refrigerant target pressure and the chiller refrigerant pressure.

The operations may be repeated such that the mode of operation may be changed as the demand for cabin cooling and the demand for battery cooling changes. The thermal management controller 230 may be programmed to, responsive to cabin cooling demand becoming zero, change from adjusting the compressor speed responsive to changes in the evaporation temperature to adjusting the compressor speed responsive to changes in the chiller refrigerant pressure. Further, responsive to the cabin cooling demand becoming nonzero, the thermal management controller 230 may change to adjusting the compressor speed responsive to changes in the evaporator temperature.

FIG. 4 depicts a possible block diagram for operating the compressor 208 in the second mode of operation. A first signal 402 that is indicative of the chiller refrigerant pressure and a second signal 404 that is indicative of the chiller refrigerant target pressure may be input to an error function 406. The second signal 404 may be derived from the chiller refrigerant target temperature. The chiller refrigerant target temperature may be input to function 414 that is configured to convert the refrigerant target temperature to the refrigerant target pressure. For example, the function 414 may implement a table look-up function as described previously herein. The error function 406 may output a signal that is the difference between the second signal 404 and the first signal 402. The output of the error function may be received by a proportional-integral (PI) control block 408. The PI control block 408 may implement a proportional-integral control strategy to adjust the compressor speed as the error changes. Other control strategies may also be utilized. In some configurations, the compressor speed signal 412 may be a target speed that is provided to a speed control system for the compressor. In some configurations, the compressor speed signal 412 may be a voltage or current provided to the compressor 208 to change the speed. In some configuration, the compressor speed signal 412 may be transferred to a compressor speed control system over the vehicle network.

As described, in the presence of a demand for cabin cooling, the compressor speed may be controlled to satisfy the cabin cooling demand. This may be independent of the demand for battery cooling. Battery cooling demand that occurs at the same time may affect the refrigerant temperature. These changes will be reflected in the cabin evaporator refrigerant temperature. The system will control the compressor 208 to ensure that the cabin cooling demand is satisfied. For example, while there is a demand for both cabin and battery cooling, the thermal management controller 230 may operate that compressor at a higher speed when compared to when there is a demand for only cabin cooling. In the absence of cabin cooling demand in the presence of a demand for battery cooling, this particular control strategy may no longer be effective as refrigerant may not be flowed to the cabin evaporator 206. As such, an alternative strategy may be implemented as described.

When the cabin cooling demand becomes zero, the compressor speed control may be changed. The refrigerant loop supports the battery chiller 204 in this mode and the compressor 208 may be operated at a different speed than in the previous control mode. The compressor speed control strategy may be changed in response to a demand for cabin cooling becoming zero. As the thermal management controller 230 changes to a different control strategy when the cabin cooling demand becomes zero, it is possible that the compressor operating speed may change. The compressor 208 may be operated to provide enough work to satisfy the battery cooling demand. The advantage of this strategy is that the compressor speed may decrease which results in fuel savings and lower noise. During the transition between control modes, the compressor speed may be filtered or changed gradually to the updated compressor speed to avoid rapid compressor speed changes.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a coolant loop configured to flow a coolant through a battery;
a compressor configured to pressurize refrigerant that selectively flows through a chiller for the coolant and an evaporator for cabin cooling; and
a controller programmed to, responsive to cabin cooling demand becoming zero, change from adjusting compressor speed responsive to changes in an evaporator refrigerant temperature to adjusting compressor speed responsive to changes in a chiller refrigerant pressure.

2. The vehicle of claim 1 wherein the controller is further programmed to, responsive to cabin cooling demand becoming nonzero, change from adjusting compressor speed responsive to changes in the chiller refrigerant pressure to adjusting compressor speed responsive to changes in the evaporator refrigerant temperature.

3. The vehicle of claim 1 wherein the controller is further programmed to, responsive to cabin cooling demand being zero, further adjust compressor speed responsive to changes in a chiller refrigerant target temperature.

4. The vehicle of claim 3 wherein the controller is further programmed to, responsive to cabin cooling demand being zero, adjust compressor speed responsive to changes in an error between a chiller refrigerant target pressure derived from the chiller refrigerant target temperature and the chiller refrigerant pressure.

5. The vehicle of claim 4 wherein the controller is further programmed to derive the chiller refrigerant target pressure based on a type of refrigerant.

6. The vehicle of claim 3 wherein the controller is further programmed to change the chiller refrigerant target temperature responsive to changes in a coolant temperature associated with the battery.

7. The vehicle of claim 3 wherein the controller is further programmed to change the chiller refrigerant target temperature responsive to changes in a temperature associated with the battery.

8. A vehicle thermal system comprising:
a compressor configured to pressurize refrigerant that selectively flows through a chiller for battery coolant and an evaporator for cabin cooling; and
a controller programmed to, responsive to cabin cooling demand becoming zero, change from adjusting compressor speed responsive to changes in an evaporator temperature to adjusting compressor speed responsive to changes in a chiller refrigerant pressure.

9. The vehicle thermal system of claim 8 wherein the controller is further programmed to, responsive to cabin cooling demand becoming nonzero, change from adjusting compressor speed responsive to changes in the chiller refrigerant pressure to adjusting compressor speed responsive to changes in the evaporator temperature.

10. The vehicle thermal system of claim 8 wherein the controller is further programmed to, responsive to cabin cooling demand being zero, adjust compressor speed responsive to changes in a chiller refrigerant target temperature.

11. The vehicle thermal system of claim 10 wherein the controller is further programmed to, responsive to cabin cooling demand being zero, adjust compressor speed responsive to changes in an error between the chiller refrigerant pressure and a chiller refrigerant target pressure that is derived from the chiller refrigerant target temperature.

12. The vehicle thermal system of claim 11 wherein the controller is further programmed to derive the chiller refrigerant target pressure based on a type of refrigerant.

13. The vehicle thermal system of claim 10 wherein the controller is further programmed to change the chiller refrigerant target temperature responsive to changes in a coolant temperature associated with a battery through which the battery coolant flows.

14. The vehicle thermal system of claim 10 wherein the controller is further programmed to change the chiller refrigerant target temperature responsive to changes in a temperature associated with a battery through which the battery coolant flows.

15. A method for operating, in a vehicle, a compressor configured to pressurize refrigerant that selectively flows through a chiller for battery coolant and an evaporator for cabin cooling comprising:
responsive to a demand for cabin cooling becoming zero, changing, by a controller, from adjusting a speed of the compressor responsive to changes in a temperature of the evaporator to adjusting the speed responsive to changes in a refrigerant pressure associated with the chiller.

16. The method of claim 15 further comprising changing, by the controller, responsive to the demand for cabin cooling demand becoming nonzero, from adjusting the speed responsive to changes in the refrigerant pressure to adjusting the speed responsive to changes in the temperature of the evaporator.

17. The method of claim 15 further comprising adjusting, by the controller, responsive to cabin cooling demand being zero, compressor speed responsive to changes in a chiller refrigerant target temperature.

18. The method of claim 17 further comprising adjusting, by the controller, responsive to cabin cooling demand being zero, compressor speed responsive to changes in an error between the refrigerant pressure and a chiller refrigerant target pressure that is derived from the chiller refrigerant target temperature.

19. The method of claim 17 further comprising changing, by the controller, the chiller refrigerant target temperature responsive to changes in a temperature associated with the battery coolant.

20. The method of claim 17 further comprising changing, by the controller, the chiller refrigerant target temperature responsive to changes in a temperature associated with a battery through which the battery coolant flows.
